(19) United States
(12) Patent Application Publication
(10) Pub. No.: US 2004/0230673 A1
(43) Pub. Date: Nov. 18, 2004

(54) Virtual counter device tolerant to hardware counter resets

(75) Inventors: Adam C. Lange-Pearson, Rochester, MN (US); Robert L. Holtorf, Rochester, MN (US); David Jones, Rochester, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: International Business Machines Corporation, Armonk, NY

(21) Appl. No.: 10/418,347

(22) Filed: Apr. 17, 2003

(51) Int. Cl. G06F 15/173

(52) U.S. Cl. 709/223

(57) ABSTRACT

Methods, systems, and articles of manufacture for maintaining a virtual counter in a logically partitioned computer system are described. The virtual counter may be based on a remote counter. For some embodiments, while a reset to the remote counter is not in progress, a value of the virtual counter generated based on the remote counter, as well as a current value of an independent counter (e.g., running independently of the remote counter and not affected by a remote counter reset) is stored. While a reset to the remote counter is in progress, an estimated value of the virtual counter may be generated based on the previously stored value of the virtual persistent clock, the previously stored value of the independent counter, and a current value of the independent counter.

### BACKGROUND OF THE INVENTION

1. Field of the Invention

The present invention generally relates to logically partitioned systems and more particularly to transparent recovery from the failure of a remote counter device used for system timing purposes in a logically partitioned system.

2. Description of the Related Art

In a computing environment, parallel processing generally refers to performing multiple computing tasks in parallel. Traditionally, parallel processing required multiple computer systems, with the resources of each computer system dedicated to a specific task, or allocated to perform a portion of a common task. However, recent advances in computer hardware and software technologies have resulted in single computer systems capable of highly complex parallel processing, by logically partitioning the system resources to different tasks. In a logically partitioned computer system, available system resources are allocated among multiple logical partitions, each designed to appear to operate independently of the other. Management of the allocation of resources among logical partitions is typically accomplished via a layer of software components, commonly referred to as a partition manager.

An objective of the partition manager is to allow each logical partition to independently run software (e.g., operating systems and operating system-specific applications), typically developed to run on a dedicated computer system, with little or no modification. For example, one logical partition may be running a first operating system, such as IBM's OS/400, a second logical partition may be running a second operating system, such as IBM's AIX, while a third logical partition may be running a third operating system, such as Linux. By providing the ability to run multiple operating systems on the same computer system, a logically partitioned system may provide a user with a greater degree of freedom in choosing application programs best suited to the user's needs with little or no regard to the operating system for which an application program was written.

The partition manager typically accomplishes the objective of allowing each of the logical partitions to independently run software by presenting each logical partition with a set of virtual resources (software components) that operate, from the perspective of the logical partition, in an identical manner to corresponding hardware components. In other words, the partition manager may allow each logical partition to, in affect, operate as an independent virtual computer system (or virtual machine) with its own set of virtual resources.

One example of a virtual resource that may be provided to each virtual machine is a virtual counter that returns a monotonically increasing or decreasing value. Because the value of the virtual counter is monotonically increasing or decreasing, it may be used as a reference for various system timing purposes (e.g., the elapsed time between events may be calculated based on a change in value of the virtual counter). The virtual counter may be derived from any continuous running counter source that returns a monotonic increasing or decreasing value, such as a free-running counter register of a processor driven by the processor's oscillator. However, free-running counter registers of a processor may not meet the accuracy requirements for some applications. For example, the virtual counter may be used for various system timing purposes, such as maintaining a time of day and date (which may be collectively referred to herein as a TOD value), which may require a greater accuracy than the free-running counter register of the processor is able to provide.

Therefore, for such applications, the virtual counter may be derived from a more accurate remote counter device that is accessible, for example, on a system bus. Typically, these applications require (or at least expect) that successive reads of this remote counter device return a monotonically increasing value throughout the runtime of the system. However, if this remote counter device should be reset, for example, due to an internal failure or a failure of another component possibly residing on the same integrated circuit (IC), the remote counter value and, thus, the virtual counter value will typically be cleared or undefined. Further, the remote counter may also become unavailable in various situations, such as a bus access failure. In either case, applications accessing the virtual counter may not see monotonically increasing values when comparing pre-reset reads with post-reset reads, which may lead to incorrect or invalid time period calculations with possibly catastrophic results, including system failures.

Accordingly, there is a need for an improved method and system for providing a virtual counter having a value that is maintained during and after resets to a counter device on which it is based.

### SUMMARY OF THE INVENTION

The present invention generally is directed to methods, systems, and articles of manufacture for maintaining a virtual counter in a logically partitioned computer system.

One embodiment provides a method for maintaining a monotonically increasing or decreasing virtual counter during and after reset of a first counter on which the virtual counter is based. The method generally includes determining if a reset of the first counter is in progress and, in response to determining a reset of the first counter is in progress, calculating a value for the virtual counter based on a previously saved value of the virtual counter, a corresponding previously saved value of a second counter operated independently of the first counter, and a current value of the second counter. For some embodiments, this second counter may be less accurate than the first counter, but will typically always be available (e.g., as a free-running counter register of a system processor).

Another embodiment provides a computer-readable medium containing a program for maintaining a virtual counter. When executed by a processor, the program performs operations generally including determining if a reset of a first counter, on which the virtual counter is based, is in progress and, in response to determining a reset of the first counter is in progress, calculating a value for the virtual counter based on a previously saved value of the virtual counter, a corresponding previously saved value of a second counter operated independently of the first counter, and a current value of the second counter.

Another embodiment provides a logically partitioned computer system generally including a first counter, a second counter operating independently of the first counter, and a virtual counter interface. The virtual counter interface is generally configured to receive requests for a virtual counter value, determine if a reset to the first counter is in progress and, if so, calculate a virtual counter value based on a previously stored virtual counter value, a corresponding previously stored value of the second counter, and a current value of the second counter.

Another embodiment provides a method for detecting a reset to a system interval timer that may be used, for example, to compensate for system delays in a transaction between entities. The method generally includes: a) taking a first reading of a reset counter indicative of a number of resets that has been performed on the system interval timer, b) taking one or more readings from the system interval timer, c) taking a second reading of the reset counter, and d) utilizing the one or more readings of the system interval timer for timing purposes only if the first and second readings of the reset counter match.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a logically partitioned computer system illustratively utilized in accordance with an embodiment of the present invention.

FIG. 2 is a relational view of software and hardware components in accordance with an embodiment of the present invention.

FIG. 3 is a flow chart illustrating exemplary operations for returning a persistent counter value in accordance with an embodiment of the present invention.

FIG. 4 is a flow chart illustrating exemplary operations for recovering from a failure in a counter device in accordance with an embodiment of the present invention.

FIG. 5 is a flow chart illustrating an exemplary system interval timer session in accordance with an embodiment of the present invention.

### DETAILED DESCRIPTION OF THE PREFERRED EMBODIMENTS

The present invention generally is directed to a method, system, and article of manufacture for providing a virtual counter, the value of which is maintained during and after periods of unavailability of a remote counter on which it is based. The remote counter may be unavailable due to a reset, for example, or a bus failure. According to one aspect, when a client (e.g., an application running in a logical partition) reads the virtual counter (or periodically), two values of data are saved for use in the event of a reset to the remote counter: 1) the last value of the virtual counter returned to the requesting client, and 2) a current value of another counter that runs independently of the remote counter (e.g., a free-running counter register of a processor). When a reset of the remote counter is in progress, or the remote counter is unavailable for some reason (e.g., a bus failure), clients accessing the virtual counter are returned a value derived from the previously saved last returned virtual counter value, and an estimated change in the virtual counter value based on the difference between the previously saved value of the independent counter and its current value.

As used herein, the term virtual counter generally refers to a software component that returns a value that is derived from a remote counter having a substantially monotonic increasing or decreasing value. The term remote counter generally refers to any type of (incrementing or decrementing) counting device that may be reset independently of a processor executing instructions for accessing the remote counter, and may include a remote counting device accessible by the processor via a bus or a free-running counter register of another processor. While the virtual counter may be used for a number of different timekeeping purposes, the following description may refer to maintaining a virtual persistent (real time) clock as a specific, but not limiting, exemplary application of the virtual counter.

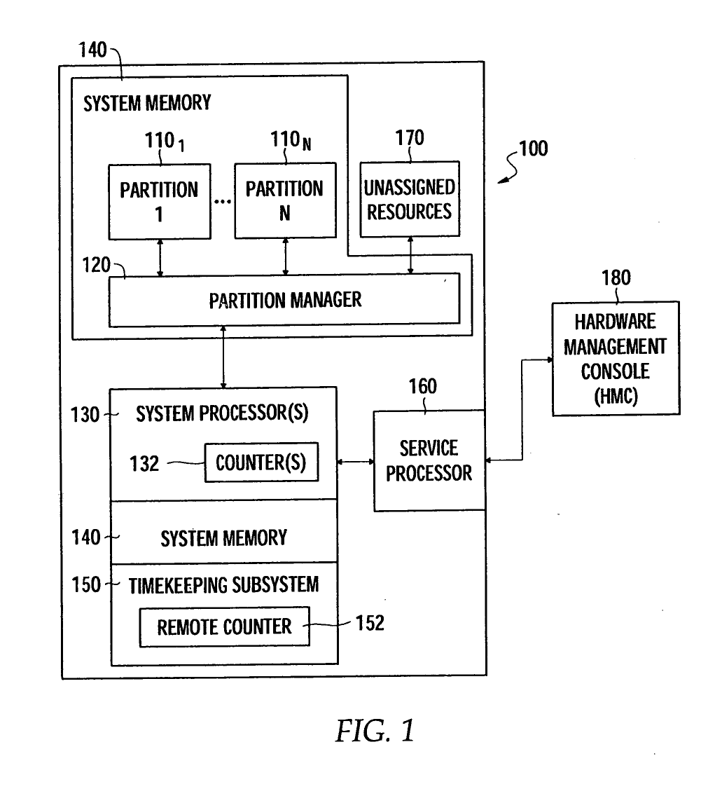

One embodiment of the invention is implemented as a program product for use with a computer system such as, for example, the logically partitioned computer system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications and the Internet.

In general, the routines executed to implement the embodiments of the invention, may be part of an operating system or a specific application, component, program, module, object, or sequence of instructions, including, for example, the partition manager 120 of the logically partitioned computer system 100 shown in FIG. 1. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified or implied by such nomenclature.

### An Exemplary Logically Partitioned System

FIG. 1 illustrates a logically partitioned computer system 100 having one or more logical partitions 110 (shown as logical partitions 110₁ through 11O_{N} to represent that any number N of logical partitions 110 may be supported). A partition manager 120 may generally control the creation and deletion of the logical partitions 110. The computer system 100 may be any suitable type of computer system capable of supporting logical partitioning, such as a network server, a mainframe computer, and the like. In one embodiment, the computer system 110 is an eServer iSeries computer system available from International Business Machines (IBM) of Armonk, N.Y.

The computer system 100 generally includes one or more system processors 130, coupled with system memory 140. The system processors 130 may be allocated among the logical partitions 110 according to any suitable allocation arrangement. For example, each logical partition 110 may have its own dedicated one or more of the system processors 130 or may share one or more of the system processors 130 with one or more other logical partitions 110. The allocation of system processors 130, system memory 140, as well as various other assigned resources and unassigned resources 170, among the logical partitions 110 may be controlled by the partition manager 120.

In addition to the system processors 130, the computer system 100 may include a service processor 160, which is generally configured to run continuously and independently of the partition manager 120, including when the partition manager 120 is not running. The service processor 160 typically runs specialized firmware code to run portions of initial program loads (IPLs), which may include component testing. As such, the service processor 160 usually has controlling access to hardware including the ability to start and stop system processors 130 and read fault isolation registers in various components. The service processor 160 may also be available to help diagnose system problems that may occur during run time. The service processor 160 may be implemented as a microprocessor, such as a PowerPC processor available from IBM, programmed (via internal or external memory) to perform the operations and functions described herein.

The service processor 160 may serve as an interface to a hardware management console (HMC) 180. The HMC 180 may be implemented as a custom configured personal computer (PC) connected to the computer system 100 (typically using the service processor 160 as an interface) and used to configure logical partitioning and other low-level system management. For some embodiments, similar functionality may be provided via one or more service partitions (not shown), or other similar type interfaces, that may also interface with the service processor 160.

The partition manager 120 may maintain a virtual counter for use by the logical partitions 110, based on a remote counter 152 that may be part of a time keeping subsystem 150 that may be accessed by the partition manager 120. The virtual counter may be used by the logical partitions 110 for various purposes, such as measuring time periods between events, maintaining a time of day (TOD) value, or any similar such purposes.

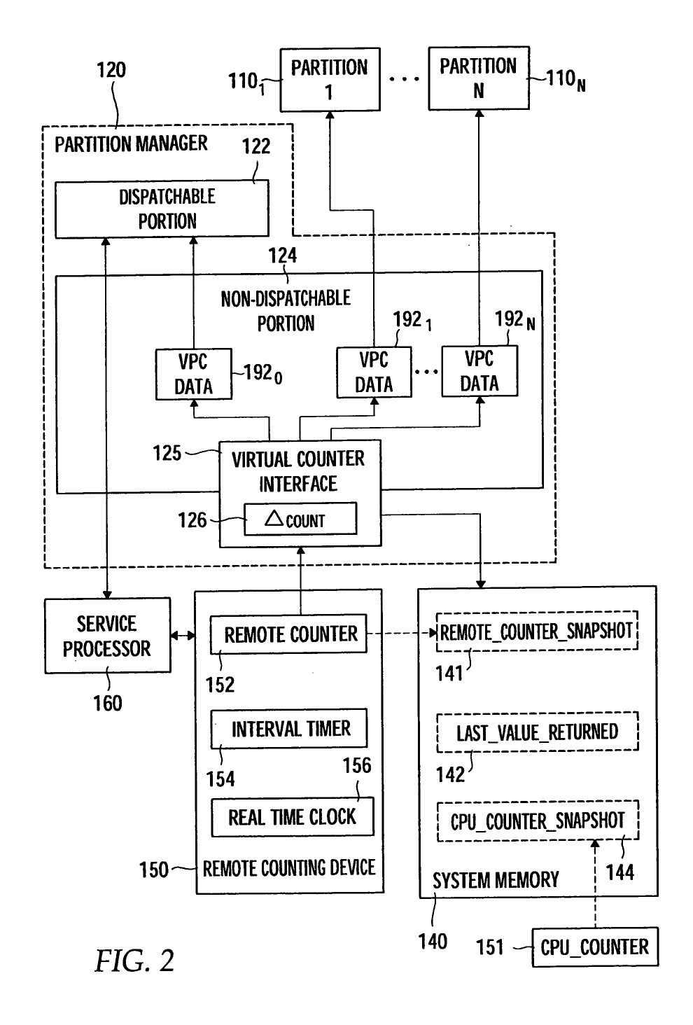

As will be described in greater detail below, the virtual counter may be maintained during and after resets to the remote counter 152 by estimating a current value of the virtual counter based on a previously stored value of the virtual counter, a corresponding snapshot value of an independent counter, and a current value of the independent counter. The independent counter may be any suitable type counting device that operations independently of the remote counter 152, such as a CPU counter (e.g., a free-running counter 132 of the system processors 130 or a free-running counter 162 of the service processor 160), or any other suitable type counter. While this second counter may be less accurate than the first counter, it will typically always be available (e.g., during situations when the remote counter 152 is not available). To facilitate understanding, the independent counter will be referred hereinafter simply as CPU counter 151 (shown in FIG. 2). Further, while the remote counter 152 and CPU counter may have increasing or decreasing values, it will be assumed, for the following discussion, that each maintains a monotonically increasing value.

FIG. 2 is a relational view of hardware and software components according to one embodiment of the invention. As illustrated, the partition manager 120 may be implemented as two generally separate layers of code, including a dispatchable portion 122 and a non-dispatchable portion 124. The non-dispatchable portion 124 is generally implemented as system firmware of the computer system 100, provides low-level partition management functions, such as transport control enablement, page-table management, and contains the data and access methods needed to configure, service, and run multiple logical partitions 110.

The dispatchable portion 122 generally handles higher-level partition management functions, such as virtual service processor functions, and starting/stopping partitions. For some embodiments, the dispatchable portion 122 of the partition manager 120 may also control when the remote timekeeping system 150 or any components thereof are reset, for example, in response to detecting a failure therein. As illustrated, the timekeeping subsystem 150 may include the remote counter 152, a system interval timer (SIT) 154 and a real time clock (RTC) 156, which may each be used in conjunction with the remote counter 152 for various timekeeping purposes, as will be described in greater detail below.

### Example Application of the Virtual Counter

As illustrated, the dispatchable portion 124 may also include a virtual counter interface 125 which may be generally configured to receive requests for a virtual counter value from requesting clients, which may include the logical partitions 110, as well as by the dispatchable portion 122. The virtual counter may be generally configured to As illustrated, the virtual counter interface 125 may access the remote counter 152, as well as various “snapshot” values stored in memory 140, for use in generating a virtual counter value to return to the requesting clients. The requesting clients may use the returned virtual counter value in a number of ways.

For example, for some embodiments, the logical partitions 110 and the dispatchable portion 122 may maintain virtual persistent clocks (VPCs) based on the virtual counter. The VPCs may be implemented according to a number of different techniques. For example, for some embodiments, each VPC may be implemented by maintaining offset values from the virtual counter. As illustrated, the offset values may be stored as VPC data 192. Depending on the implementation, the VPC data 192 may contain an explicit offset value or data sufficient to generate the offset value. Regardless, a current value for each VPC may be calculated by adding its corresponding offset value (Δ COUNT) to a current value of the virtual counter (VRT_CNT_{CURRENT}) as shown by the following equation:

VPC_{CURRENT}=VRT_CNT_{CURRENT}+Δ_{COUNT}.

One of the basic requirements of the VPCs (and similar type components) is that their value be monotonically increasing, otherwise system timing and time period calculations based on the VPCs may be incorrect or invalid with possibly catastrophic results. Therefore, it is important that the virtual counter on which the VPCs are based return a monotonically increasing value.

As previously described, conventional virtual counters based on the remote counter 152 may be cleared upon occurrence of a reset to the remote counter 152. However, embodiments of the present invention provide a virtual counter that maintains a monotonically increasing value, even during and after resets to the remote counter 152. As illustrated in FIG. 2, various values related to the virtual counter may be stored (e.g., in memory 140) for use in the event of a reset to the remote counter 152. For example, as shown, the last returned virtual counter value 142 and a corresponding snapshot value of the CPU counter 144 may be stored, for example, each time a request to read the virtual counter is received. As described below, these stored values may be used in the event of a reset to the remote counter 152 to estimate values for the virtual counter using a current value of the CPU counter 151.

### Virtual Counter Maintenance During Remote Counter Reset

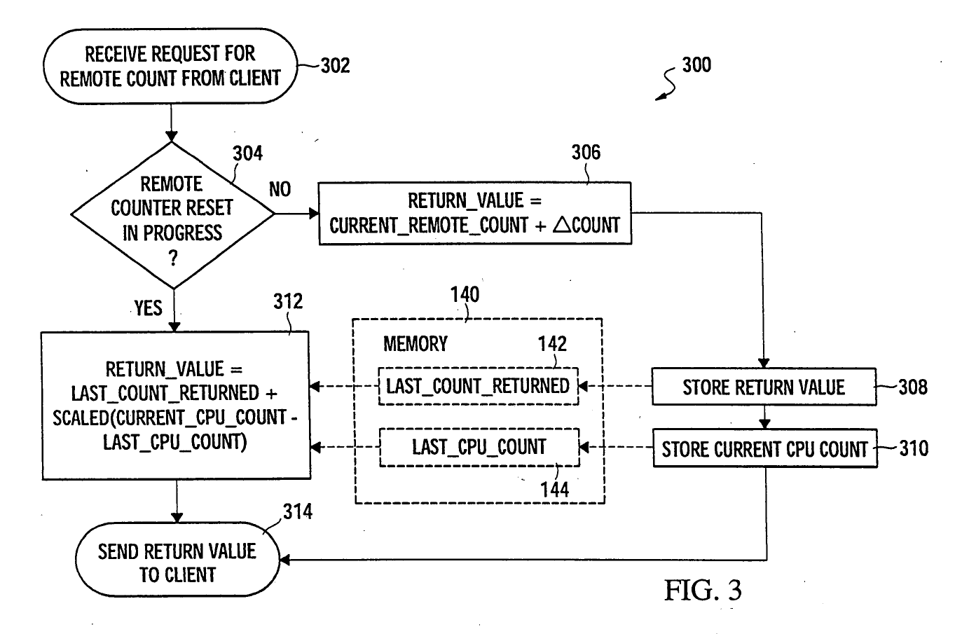

For example, FIG. 3 illustrates exemplary operations 300 that may be performed, for example, by the virtual counter interface 125, to return an estimated value of the virtual counter while a reset of the remote counter 152 is in progress. In other words, the estimated value of the virtual counter may be returned during the relatively short “reset time window” between initiation and completion of reset of the remote counter 152. The operations 300 may be best described with simultaneous reference to FIG. 2.

The operations 300 begin at step 302, by receiving a request for a virtual counter value from a client. For example, the requesting client may be a component of a logical partition 110 that maintains a VPC for the logical partition 110. At step 304, a determination is made as to whether a reset to the remote counter 152 is in progress (or the remote counter 152 is otherwise unavailable). For some embodiments, this determination may be made simply by examining a value of the remote counter 152. For example, upon encountering a reset, the remote counter 152 may be set to a value designed to indicate a reset has occurred, or the counter interface 125 may detect a reset to the remote counter 152 if a value is returned that is lower than a previously read value. As an alternative, a reset to the remote counter 152 may be made by examining a status flag (e.g., a bit in a status register associated with the remote counter 152) or by examining a reset counter associated with the remote counter.

For example, in one particular embodiment, the service processor 160 may detect a critical problem with the timekeeping subsystem 150 and notify the dispatchable portion 124 of the partition manager 120. In response to the notification, the dispatchable portion 124 may invoke a method to initiate a reset of the timekeeping subsystem 150. Within this method, a reset counter may be incremented to indicated a reset is in progress. Upon detecting the reset is complete, the dispatchable portion 124 may call another method to complete the reset, in which the reset counter may be incremented again to indicate the reset is complete. Therefore, a change in the reset counter may indicate a reset has occurred. Further, because the lowest bit of the reset counter will be toggled with each increment, its state may also provide an indication of whether a reset is in progress.

Regardless of the particular implementation and technique for detecting a reset, if a reset of the remote counter 152 is not in progress, a return value for the virtual counter is calculated, at step 306, based on the current value of the remote counter 152. For example, for some embodiments, the return value for the virtual counter may be calculating by adding an offset value (shown in FIG. 2 as ΔCOUNT 126) to the current value of the remote counter 152 (RMT₁₃ CNT_{CURRENT}), as follows:

VRT_CNT_{CURRENT}=RMT_CNT_{CURRENT}+Δ_{COUNT}.

As will be described in greater detail below, the offset value (Δ COUNT 126) may be adjusted to account for resets to the remote counter 152.

As previously described, the return value of the virtual counter and a corresponding snapshot value of the CPU counter may be stored (as registers 142 and 144, respectively) for later use in the event of a reset to the remote counter. Therefore, at step 308, the return value is stored and, at step 310, a snapshot value of the CPU counter is stored, prior to sending the return value to the requesting client at step 314.

Referring back to step 302, if a client request for a virtual counter value is received while a reset of the remote counter 152 is in progress, as determined at step 304, an estimate of the virtual counter is calculated, at step 312. The estimated value (VRT_CNT_{EST}) may be calculated based on the stored last returned value 142 (VRT_CNT_{LAST}), the corresponding stored value 144 of the CPU counter 151 and a current count of the CPU counter 151, using the following equation:

VRT_CNT_{EST}=VRT_CNT_{LAST}+(CPU_{CURRENT}−CPU_{LAST})_{SCALED}.

As illustrated, because the CPU counter 151 and remote counter 152 may be operating at different frequencies, the difference in the current and last CPU counter values may be scaled accordingly. The second term on the right hand side of the equation represents an estimate change in value of the virtual counter based on a measured difference in the CPU counter value since the last virtual counter value was returned.

In other words, for the relatively short duration while the remote counter 152 is being reset, the virtual counter is based on the CPU counter 151 instead. While the CPU counter 151 may not be as accurate as the remote counter 152, for the relatively short duration of the reset, the CPU counter 151 should provide reasonably accurate estimates of the virtual counter. Once the remote counter 152 reset is complete, however, the offset value (Δ COUNT 126) used to calculate the virtual counter from the remote counter 152 may be updated to account for a change in value of the remote counter 152 due to the reset.

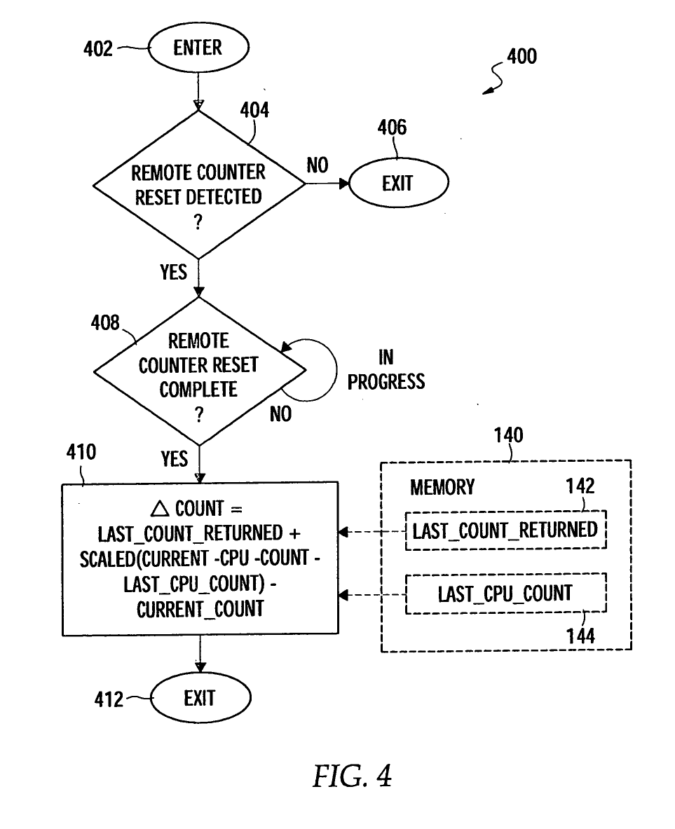

FIG. 4 illustrates exemplary operations 400 that may performed to adjust the counter deltas 192 of partitions 110 to compensate for the reset of the remote counter 152. The operations 400 are entered at step 402 and, at step 404, a determination is made as to whether a reset of the remote counter 152 is detected. As previously described, for some embodiments, a reset of the remote counter 152 may be detected based on a reset counter value that may be incremented when a reset is initiated and again when the reset is complete. If no reset is detected, the operations 400 are exited, at step 406.

On the other hand, if a remote counter reset is detected, a wait loop is entered, at step 408. Of course, the wait loop 408 is illustrative only, and, as shown in FIG. 3, processing actually continues while the reset of the remote counter 152 is in progress (e.g., the partition manager 120 may continue to receive requests to read the virtual counter). Regardless, once the remote counter reset is complete, at step 410, the virtual counter offset (Δ_{COUNT} 126) may be adjusted to compensate for the estimated change in the remote counter 152 due to the reset. For example, a new offset value (Δ_{NEW}) may be calculated according to the following equation:

Δ_{NEW}=VRT_CNT_{AST}+(CPU_{CURRENT}−CPU_{LAST})_{SCALED}−RMT_CNT_{CURRENT}.

By comparing this equation to the equation above for VRT_CNT_{EST}, it may be recognized that this new offset value (Δ NEW) is essentially calculated by subtracting the current value of the remote counter 152 from an estimated value of the virtual counter (VRT_CNT_{EST}). Using this new offset value, current virtual counter values, compensated for the reset to the remote counter 152, can be calculated.

For some embodiments, rather than adjust the offset value (Δ_{COUNT} 126) for the virtual counter, the value of the remote counter 152 may be set to an estimated value it would have reached had the reset not occurred. For example, the value the remote counter 152 would have reached (RMT₁₃ CNT_{EST}) may be estimated using the following equation:

RMT_CNT_{EST}=RMT_CNT_{LAST}+(CPU_{CURRENT}−CPU_{LAST})_{SCALED}.

where RMT_CNT_{LAST} is a snapshot value 141 of the remote counter 152 which may be stored, for example, when the last value returned 142 and the last CPU counter value 144 (CPU_{LAST}) are stored. If the remote counter 152 is adjusted, the virtual counter and remote counter 152 are essentially synchronized, thus, the offset value of the virtual counter (Δ_{COUNT} 126) may be cleared.

### Session Interval Timers

For some embodiments, the partition manager 120 may also be configured to utilize the remote counter 152 as a reference for system time, and utilize the RTC 156 to maintain the system time in the event of a power down, as described above. However, as the RTC 156 and remote counter 152 may have slightly different resolutions and accuracy, a drift may occur between the real time derived from the remote counter 152 and the real time derived from the RTC 156. Therefore, in order to minimize this drift, the dispatchable portion 122 of the partition manager 120 may be configured to periodically synchronize the RTC 156 and the remote counter 152, for example, by periodically updating the RTC 156 based on the value of the remote counter 152.

However, there may be various system delays associated with reading and writing the RTC 156, for example, due to a communications protocol between the disposable portion 124 of the partition manager 120 and the service processor 160. To account for these delays, the timekeeping subsystem 150 may include a system interval timer (SIT) 154. The SIT 154 may operate off the same oscillator as the remote counter 152. For some embodiments, the SIT 154 may have a decreasing value to facilitate period measurements. For example, the time period between two events may be measured by setting the SIT 154 (e.g., to all 1's) upon occurrence of the first event, reading the SIT 154 upon occurrence of the second event, and taking the difference between the two readings. The SIT 154 may be used to account for system delays when reading from or writing to the RTC 156.

However, the SIT 154 may be prone to occasional resets which may render readings invalid for such system timing purposes. As described above, with reference to the remote counter 152, resets to the SIT 154 may also be detected by examining a reset counter that is indicative of the number of resets that have occurred to the SIT 154 (in fact, for some embodiments, the remote counter 152 and SIT 154 are on the same IC and are reset together when a failure on the IC is detected). For example, the reset counter may be incremented once upon initiation of a reset and again upon completion of the reset. Therefore, as previously described, a change in the reset counter indicates a reset has occurred, and the lowest bit of the reset counter may indicate whether a reset is in progress (i.e., ‘1’ for reset in progress, ‘0’ for reset complete or vice-versa).

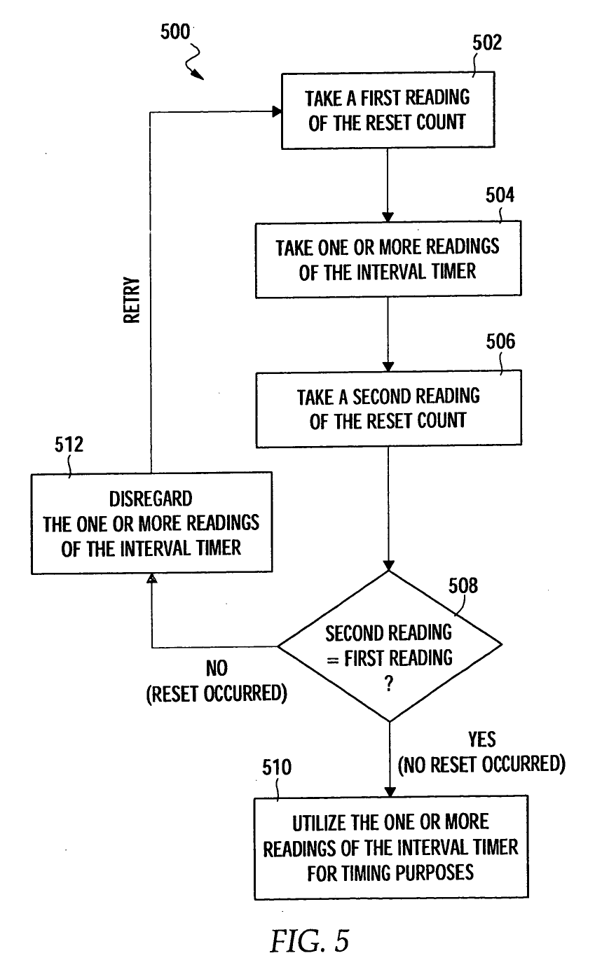

FIG. 5 illustrates exemplary operations 500 that illustrate how this reset counter may be used when attempting to utilize the SIT 154 for system timing purposes. The operations 500 begin, at step 502, by taking a first reading the reset counter. At step 504, one or more readings of the SIT 154 are taken.

For example, a first reading of the SIT 154 may be taken just prior to sending a new value to be written to the RTC 156, while a second reading may be taken just prior to writing the new value to the RTC 156. The difference between the first and second values may be added to the new value to be written to the RTC 156 to compensate for system delays. However, prior to writing this new value to the RTC 156, a second reading of the reset counter may be taken, at step 506, to ensure the SIT 154 was not reset between taking the one or more readings, which may render the one or more readings invalid.

At step 508, the first and second readings of the reset counter are compared. A match between the first and second readings of the reset counter indicate no reset has occurred to the SIT 154. Therefore, at step 510, the one or more readings of the SIT 154 should be valid, and may be used for system timing purposes. On the other hand, a difference between the first and second readings of the reset counter indicates a reset has occurred to the SIG 154. Therefore, at step 512, the one or more readings of the SIT 154 are disregarded and the SIT “session” may be repeated, by returning to step 502.

### Conclusion

Embodiments of the present invention allow the integrity of a virtual counter to be maintained during and after resets to a remote counter on which it is based. The virtual counter may be implemented by maintaining an offset from the remote counter. While a reset to the remote counter is in progress, another counter, operating independently of the remote counter, such as a CPU counter, may be used to estimate a value of the virtual counter. Upon completion of the reset to the remote counter, the virtual counter may be adjusted to compensate for the reset, for example, by adjusting the offset from the remote counter or adjusting the remote counter value itself.

While the foregoing is directed to embodiments of the present invention, other and further embodiments of the invention may be devised without departing from the basic scope thereof, and the scope thereof is determined by the claims that follow.

What is claimed is:

1. A method for maintaining at least one virtual counter based on a first counter, comprising:
determining if a reset of the first counter is in progress; and
in response to determining a reset of the first counter is in progress, calculating a value for the virtual counter based on a previously saved value of the virtual counter, a corresponding previously saved value of a second counter operated independently of the first counter, and a current value of the second counter.

2. The method of claim 1, further comprising, in response to determining a reset of the first counter is not in progress:
calculating a value of the virtual counter based on a current value of the first counter;
saving the calculated value for the virtual counter based on the current value of the first counter; and
saving a current value of the second counter.

3. The method of claim 2, wherein calculating a value for the virtual counter based on a current value of the first counter comprises adding an offset value to the current value of the first counter.

4. The method of claim 1, further comprising, maintaining a virtual persistent clock based on the virtual counter.

5. The method of claim 1, wherein determining whether a reset for the first counter is in progress comprises examining a value of a register indicative of the number of resets that have occurred for the first counter.

6. The method of claim 1, further comprising, in response to determining a reset to the first counter is complete, adjusting one or more data elements used to generate values for the virtual counter to compensate for a reset value of the first counter.

7. The method of claim 6, wherein adjusting one or more data elements used to generate values for the virtual counter to compensate for a reset value of the first counter comprises:
estimating a value the first counter would have reached had the reset to the first counter not occurred; and
setting the first counter to the estimated value.

8. The method of claim 6, wherein adjusting one or more data elements used to generate values for the virtual counter to compensate for a reset value of the first counter comprises adjusting an offset value used to generate a value for the virtual counter from the first counter based on:
a previously stored value of the virtual counter;
a previously stored value of the second timer corresponding to the previously stored value of the virtual counter;
a current value of the second counter; and
a current value of the first counter.

9. A computer-readable medium containing a program for maintaining a virtual counter which, when executed by a processor, performs operations comprising:
determining if a first counter, on which the virtual counter is based, is unavailable; and
in response to determining the first counter is unavailable, calculating a value for the virtual counter based on a previously saved value of the virtual counter, a corresponding previously saved value of a second counter operated independently of the first counter, and a current value of the second counter.

10. The computer-readable medium of claim 9, wherein determining if the first counter is unavailable comprises determining if a reset to the first counter is in progress.

11. The computer-readable medium of claim 10, wherein the operations further comprise, in response to determining a reset to the first counter is complete, adjusting one or more data elements used to generate values for the virtual counter to compensate for a reset value of the first counter.

12. The computer-readable medium of claim 11, wherein adjusting one or more data elements used to generate values for the virtual counter to compensate for a reset value of the first counter comprises:
estimating a value the first counter would have reached had the reset to the first counter not occurred; and
setting the first counter to the estimated value.

13. A logically partitioned computer system, comprising:
a first counter;
a second counter operating independently of the first counter;
at least one logical partition having a corresponding virtual counter based on the first counter; and
a partition manager configured to determine whether the first counter is unavailable and, if so, calculate a value for the virtual counters based on a current value of the second counter, a previously stored value of the virtual counter, and a corresponding previously stored value of the second counter.

14. The logically partitioned computer system of claim 13, wherein the partition manager is further configured to, in response to determining the first counter is unavailable, calculate a value for the virtual counter based on a current value of the first counter, store the calculated value, and store a corresponding current value of the second counter.

15. The logically partitioned computer system of claim 14, wherein the partition manager is configured to calculate the value for the virtual counter by adding, to the current value of the first counter, an offset value.

16. The logically partitioned computer system of claim 15, wherein the partition manager is further configured to, in response to determining a reset to the first counter is complete, adjust the offset value to compensate for a reset value of the first counter.

17. The logically partitioned computer system of claim 13, wherein the partition manager is further configured to, in response to determining a reset to the first counter is complete:
estimate a value the first counter would have reached had the reset to the first counter not occurred; and
set the first counter to the estimated value.

18. The logically partitioned computer system of claim 13, further comprising a battery-backed real time clock, wherein the partition manager is further configured to periodically synchronize the real time clock and the first counter.

19. A method for utilizing an interval timer for timing purposes, comprising:
(a) taking a first reading of a reset counter indicative of a number of resets that has been performed on the interval timer;
(b) taking one or more readings from the interval timer;
(c) taking a second reading of the reset counter; and
(d) utilizing the one or more readings of the interval timer for timing purposes only if the first and second readings of the reset counter match.

20. The method of claim 19, wherein a lower bit of the reset counter indicates whether a reset to the interval timer is in progress.

21. The method of claim 19, further comprising disregarding the one or more readings of the interval timer and repeating steps (a)-(d) if the first and second readings of the reset counter do not match.
